(19) United States
(12) Patent Application Publication
(10) Pub. No.: US 2025/0132587 A1
(43) Pub. Date: Apr. 24, 2025

(54) SYSTEMS AND METHODS FOR MOBILE CHARGING OF A USER ATTACHED MONITOR DEVICE

(71) Applicant: BI Incorporated, Boulder, CO (US)

(72) Inventor: Bradley McIntyre, Longmont, CO (US)

(73) Assignee: BI Incorporated, Boulder, CO (US)

(21) Appl. No.: 18/493,774

(22) Filed: Oct. 24, 2023

(51) Int. Cl. H02J 7/00; G06F 1/16

(52) U.S. Cl. CPC H02J 7/007; H02J 7/0047; G06F 1/163

(57) ABSTRACT

Various embodiments provide systems and methods for charging a tracking device while it is attached to a monitored individual.

### BACKGROUND OF THE INVENTION

Various embodiments provide systems and methods for locating a tracking device, and more particularly to systems and methods for locating a tracking device involving selective use of non-associated devices.

Tracking devices have been attached to monitored individuals and provide an ability to automatically determine the location of the respective monitored individual. Such tracking devices can include, for example, location determination circuitry that depends upon, for example, signal reception from location satellites, WiFi devices, and/or transmitting beacons. Each of these types of location services use differing levels of power to establish a location of a tracking device. Where power is depleted to a defined extent, such location determination circuitry can fail causing a loss of location information from the tracking device. Thus, it is important to maintain such tracking devise in a charged state. This is difficult due to an inability to detach the tracking device from a monitored individual for charging. As such a monitored individual is required to remain in place while the tracking device is charged from a fixed power source.

Thus, for at least the aforementioned reasons, there exists a need in the art for more advanced approaches, devices and systems for maintaining tracking devices that are not removable from an individual for charging.

### BRIEF SUMMARY OF THE INVENTION

Various embodiments provide systems and methods for charging a tracking device while it is attached to a monitored individual.

This summary provides only a general outline of some embodiments. Many other objects, features, advantages and other embodiments will become more fully apparent from the following detailed description, the appended claims and the accompanying drawings and figures.

### BRIEF DESCRIPTION OF THE DRAWINGS

A further understanding of the various embodiments may be realized by reference to the figures which are described in remaining portions of the specification. In the figures, similar reference numerals are used throughout several drawings to refer to similar components. In some instances, a sub-label consisting of a lower-case letter is associated with a reference numeral to denote one of multiple similar components. When reference is made to a reference numeral without specification to an existing sub-label, it is intended to refer to all such multiple similar components.

FIG. 1a-1d are block diagrams illustrating an individual monitoring system that includes a charging control circuit allowing for mobile charging while attached to a monitored individual in accordance with various embodiments;

FIG. 2a is a block diagram of a mobile charging device configured to charge a user attached monitor device in accordance with some embodiments;

FIG. 2b is a block diagram of a mobile charging device configured to charge a user attached monitor device in accordance with other embodiments;

FIG. 3 is a flow diagram showing a method in accordance with some embodiments for utilizing a mobile charging device configured to charge a user attached monitor device; and

FIG. 4 is a schematic diagram of a user attached monitor device detection circuit in accordance with some embodiments.

### DETAILED DESCRIPTION OF THE INVENTION

Various embodiments provide systems and methods for charging a tracking device while it is attached to a monitored individual.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “cell” includes reference to one or more of such cells.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the elements shown in the flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

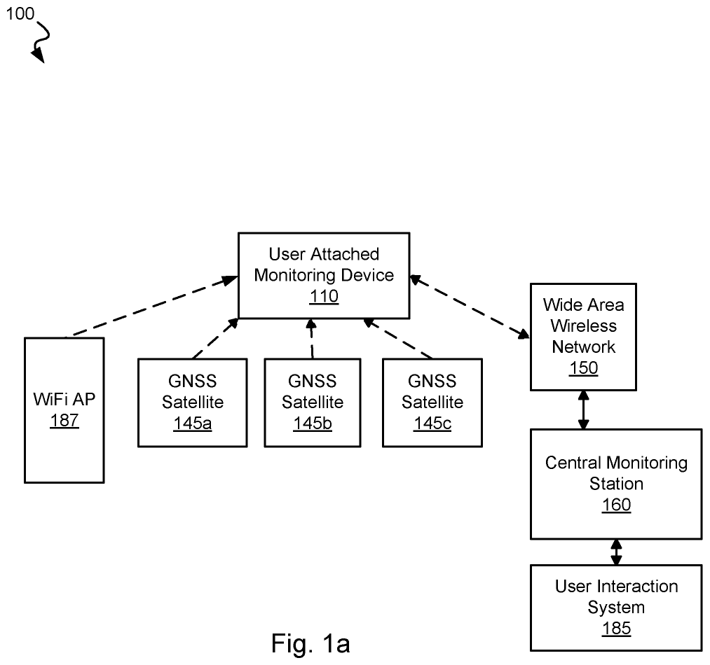

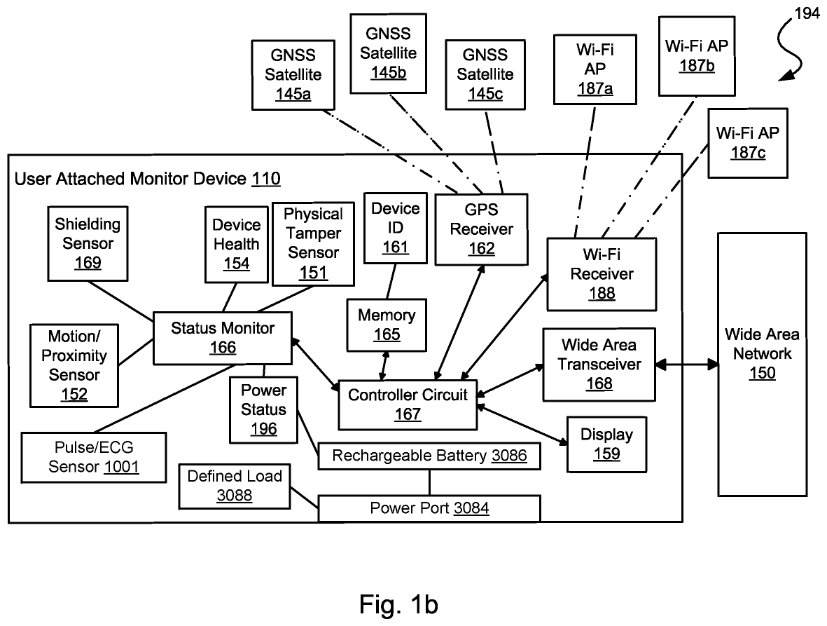

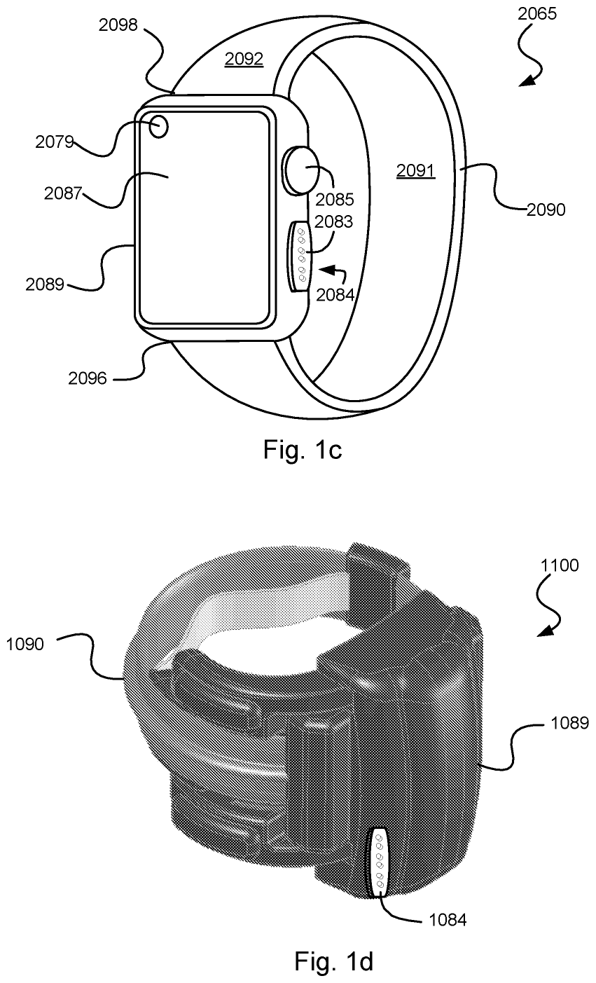

In the following description of FIGS. 1-4, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Various embodiments provide a user attached monitor device that may be attachable to a monitored individual. In some cases, the user attached monitor device is attached in a way that is not removable without either permission or causing some alarm condition to generate. Such a user attached monitor device may be re-charged using a mobile charging device capable of discerning that it is connected to the user attached monitor device. In some case, such a mobile charging device does not discharge when, for example, it is connected to ground or a load that is not discerned to be the user attached monitor device for which it is designed.

Some embodiments provide methods for maintaining a user attached monitor device that include: providing a user attached monitor device and connecting a mobile charging device to the user attached monitor device while the user attached monitor device is secured to the monitored individual. The user attached monitor device includes: a first rechargeable battery, a tool for determining a characteristic of a monitored individual, a securing mechanism for securing the user attached monitor device to the monitored individual, a first power port, and a defined load. The mobile charging device includes: a second rechargeable battery, a second power port, and a user attached monitor device detection circuit configured to determine whether the user attached monitor device is attached to the mobile charging device via the first power port and the second power port. The methods further include: upon determination by the user attached monitor device detection circuit that the user attached monitor device is attached to the mobile charging device, providing power from the second rechargeable battery to the first rechargeable battery via the first power port and the second power port; and upon determination by the user attached monitor device detection circuit that the user attached monitor device is not attached to the mobile charging device, disabling power transfer from the second rechargeable battery.

In some instances of the aforementioned embodiments, the tool includes a location tool configured to determine a location of the user attached monitor device. In various instances of the aforementioned embodiments, the tool includes a tamper tool configured to determine whether the user attached monitor device remains secured to the monitored individual. In some instances of the aforementioned embodiments, the tool includes a substance detection tool configured to determine whether the monitored individual is impaired.

In some instances of the aforementioned embodiments, the defined load comprises a finite resistance, and wherein the finite resistance interacts with a resistance in the user attached monitor device detection circuit to generate a voltage signal. In some such instances, the user attached monitor device detection circuit comprises a window comparator circuit configured to assert an enable signal when the voltage signal is between a lower threshold and an upper threshold. In some cases, the finite resistance and a resistance in the user attached monitor device detection circuit are selected such that the enable signal is asserted when the voltage signal is between one (1.0) and two and one half (2.5) volts. In various cases, the finite resistance and a resistance in the user attached monitor device detection circuit are selected such that the enable signal is asserted for a range of less than one and one half (1.5) volts. In some cases, the finite resistance and a resistance in the user attached monitor device detection circuit are selected such that the enable signal is asserted for a range of less than one half (0.5) volts.

Other embodiments provide charging apparatus that include: a rechargeable battery, a power port, user attached monitor device detection circuit, and a power transfer enable circuit. The user attached monitor device detection circuit is configured to determine whether a user attached monitor device is attached to the mobile charging device via the first power port and the second power port, and to assert an enable signal when the user attached monitor device is attached to the mobile charging device. The power transfer enable circuit is configured to disable power transfer from the rechargeable battery to the user attached monitor device when enable signal is de-asserted.

In some instances of the aforementioned embodiments, the user attached monitor device detection circuit is configured to detect a defined load in the user attached monitor device. In some such instances, the user attached monitor device detection circuit includes a series of resistors generating: a first voltage when the user attached monitor device detection circuit is not connected to the defined load, and a second voltage when the user attached monitor device is connected to the defined load. In some cases, the user attached monitor device detection circuit is configured to assert the enable signal when at least the second voltage is generated by the series of resistors. In other such instances, the user attached monitor device detection circuit includes a series of resistors generating: a first voltage and a second voltage when the user attached monitor device detection circuit is not connected to the defined load, and a third voltage and a fourth voltage when the user attached monitor device is connected to the defined load. In some cases, the user attached monitor device detection circuit is configured to assert the enable signal when both the first voltage is below a first threshold and the second voltage is above a second threshold. In some cases the first threshold is greater than the second threshold.

Yet other embodiments provide systems for monitoring an individual. The systems include: a user attached monitor device, and a mobile charging device attachable to the user attached monitor device while the user attached monitor device is attached to a monitored individual. The user attached monitor device includes: a first rechargeable battery, a tool for determining a characteristic of a monitored individual, a securing mechanism for securing the user attached monitor device to the monitored individual, a first power port, and a defined load. The mobile charging device includes: a second rechargeable battery, a second power port, a user attached monitor device detection circuit, and a power transfer enable circuit. The user attached monitor device detection circuit is configured to determine whether the user attached monitor device is attached to the mobile charging device via the first power port and the second power port, and to assert an enable signal when the user attached monitor device is attached to the mobile charging device. The power transfer enable circuit is configured to disable power transfer from the second rechargeable battery to the first rechargeable battery when enable signal is de-asserted, and to enable power transfer from the second rechargeable battery to the first rechargeable battery when enable signal is asserted.

Turning to FIG. 1a, a block diagram illustrates an individual monitoring system 100 including a user attached monitor device 110 and a central monitoring station 160. Central monitoring station 160 is wirelessly coupled to user attached monitor device 110 via one or more wide area wireless (e.g., cellular telephone network, Internet via a WiFi access point, or the like) communication networks 150.

Central monitoring station 160 may be any location, device or system where location data and/or other types of data are received, including by way of non-limiting example: a cellular/smart phone, an email account, a website, a network database, and a memory device. The location data and/or other types of data are stored by central monitoring station 160 and are retrievable by a monitoring individual, such as a parent, guardian, parole officer, court liaison, spouse, friend, or other authorized group or individual. In this manner, the monitoring individual is able to respond appropriately to detected activity of a monitored individual. In some cases, the monitoring individual is able to retrieve the location data and/or other data types via a user interaction system 185 which may be, but is not limited to, a network connected user interface device communicatively coupled via a network to central monitoring station 160 and/or directly to user attached monitor device 110 via wide area wireless network 150.

Central monitoring station 160 may include a server supported website, which may be supported by a server system comprising one or more physical servers, each having a processor, a memory, an operating system, input/output interfaces, and network interfaces, all known in the art, coupled to the network. The server supported website comprises one or more interactive web portals through which the monitor may monitor the location of the monitored individual in accordance with the described embodiments. In particular, the interactive web portals may enable the monitor to retrieve the location and user identification data of one or more monitored individuals, set or modify ‘check-in’ schedules, and/or set or modify preferences. The interactive web portals are accessible via a personal computing device, such as for example, a home computer, laptop, tablet, and/or smart phone.

In some embodiments, the server supported website comprises a mobile website or mobile application accessible via a software application on a mobile device (e.g. smart phone). The mobile website may be a modified version of the server supported website with limited or additional capabilities suited for mobile location monitoring.

User attached monitor device 110 includes a location sensor that senses the location of user attached monitor device 110 and generates corresponding location data. For example, when user attached monitor device 110 is capable of receiving wireless global navigation satellite system (hereinafter “GNSS”) location information 136, 138, 139 from a sufficient number of GPS or GNSS satellites 145 respectively, user attached monitor device 110 may use the received wireless GNSS location information to calculate or otherwise determine the location of a human subject to which user attached monitor device 110 is attached. Global positioning system (hereinafter “GPS) is one example of a GNSS location system. While GPS is used in the specific embodiments discussed herein, it is recognized that GPS may be replaced by any type of GNSS system. In some instances, this location includes latitude, longitude, and elevation. It should be noted that other types of earth-based triangulation may be used in accordance with different embodiments of the present invention. For example, other cell phone-based triangulation, UHF band triangulation such as, for example, long range (hereinafter “LoRa”) triangulation signals. Based on the disclosure provided herein, one of ordinary skill in the art will recognize other types of earth-based triangulation that may be used. The location data may comprise one or more of, but is not limited to: global positioning system (“GPS”) data, Assisted GPS (“A-GPS”) data, Advanced Forward Link Trilateration (“AFLT”) data, and/or cell tower triangulation data. Where GPS is used, user attached monitor device 110 receives location information from three or more GPS or GNSS satellites 145 via respective communication links. The location data and/or other data gathered by user attached monitor device 110 is wirelessly transmitted to central monitoring station 160 via wide area wireless network 150 accessed via a wireless link.

Further, user attached monitor device 110 includes WiFi based location determination circuitry that is configured to communicate with one or more WiFi access points 187, and based thereon to determine location of user attached monitor device 110.

Turning to FIG. 1b, a block diagram 194 of user attached monitor device 110 is shown in accordance with some embodiments. As shown, user attached monitor device 110 includes a device ID 161 that may be maintained in a memory 165, and is thus accessible by a controller circuit 167. Controller circuit 167 interacts with a GPS receiver 162 and memory 165 at times for storing and generating records of successively determined GPS locations. Similarly, controller circuit 167 interacts with a WiFi receiver 188 and memory 165 at times for storing and generating records of successively determined WiFi access point identifications and signal strength. In some cases, memory 165 may include instructions (e.g., software-based or firmware-based instructions) executable by controller circuit 167 to perform and/or enable various functions associated with user attached monitor device 110. As user attached monitor device 110 comes within range of one or more WiFi access points (e.g., a WiFi access point 187a, a WiFi access point 187b, and/or a WiFi access point 187c), WiFi receiver 188 senses the signal provided by the respective WiFi access points, and provides an identification of the respective WiFi access point and a signal strength of the signal received from the WiFi access point to WiFi receiver 188. This information is provided to controller circuit 167 which stores the information to memory 165.

Where user attached monitor device 110 is operating in a standard mode, controller circuit 167 causes an update and reporting of the location of user attached monitor device 110 via a wide area transceiver 168 and wide area communication network 150. In some embodiments, wide area transceiver 168 is a cellular telephone transceiver. In some cases, the location data is time stamped. In contrast, where user attached monitor device 110 is within range of a public WiFi access point, reporting the location of user attached monitor device 110 may be done via the public WiFi access point in place of the cellular communication link.

Which technologies (e.g., GNSS, WiFi, and/or cell tower based location) are used to update the location of user attached monitor device 110 may be selected either by default, by programming from central monitor station 160, or based upon conditions detected in user attached monitor device 110 with corresponding pre-determined selections. For example, it may be determined whether sufficient battery power as reported by power status 196 remains in user attached monitor device 110 to support a particular position determination technology.

In some cases, a maximum cost of resolving location may be set for user attached monitor device 110. For example, resolving WiFi location data or via a non-associated device may incur a per transaction cost to have a third-party service provider resolve the location information. When a maximum number of resolution requests have been issued, the WiFi position determination technology or the non-associated device approach may be disabled.

Further, it may be determined whether the likelihood that a particular position determination technology will be capable of providing meaningful location information. For example, where user attached monitor device 110 is moved indoors, GPS receiver 162 may be disabled to save power. Alternatively, where the tracking device is traveling at relatively high speeds, WiFi receiver 188 may be disabled. As yet another example, where cellular phone jamming is occurring, support for cell tower triangulation position determination may be disabled. As yet another example, where GPS jamming is occurring, GPS receiver 162 may be disabled. As yet another example, where user attached monitor device 110 is stationary, the lowest cost (from both a monetary and power standpoint) tracking may be enabled while all other technologies are disabled. Which position determination technologies are used may be based upon a zone in which a tracking device is located. Some zones may be rich in WiFi access points and in such zones WiFi technology may be used. Otherwise, another technology such as cell tower triangulation or GPS may be used. Based upon the disclosure provided herein, one of ordinary skill in the art will recognize other scenarios and corresponding combinations of technologies may be best.

Controller circuit 167 of user attached monitor device 110 at times functions in conjunction with wide area transceiver 168 to send and receive data and signals through wide area communication network 150. This link at times is useful for passing information and/or control signals between a central monitoring system 160 and user attached monitor device 110. The information transmitted may include, but is not limited to, location information, measured alcohol information, one or more passive or active impairment tests applied to the monitored individual, and information about the status of user attached monitor device 110. Based on the disclosure provided herein, one of ordinary skill in the art will recognize a variety of information that may be transferred via wide area communication network 150.

Various embodiments of user attached monitor device 110 include a variety of sensors capable of determining the status of user attached monitor device 110, and of the individual to which it is attached. For example, a status monitor 166 may include one or more of the following subcomponents: power status sensor 196 capable of indicating a power status (e.g., a charge remaining on a rechargeable battery 3086) of user attached monitor device 110, and/or a pulse/ECG sensor 1001 configured to sense pulse rate of the monitored individual and an electrocardiogram unique to the monitored individual based upon electrodes (not shown) in contact with the skin of the monitored individual. The power status may be expressed, for example as a percentage of battery life remaining. Based upon the disclosure provided herein, one of ordinary skill in the art will recognize a variety of forms in which power status may be expressed. The pulse rate may be expressed in beats per minute and the ECG may be shown visually via display 159. Based upon the disclosure provided herein, one of ordinary skill in the art will recognize a variety of forms in which pulse rate and/or ECG rate may be expressed.

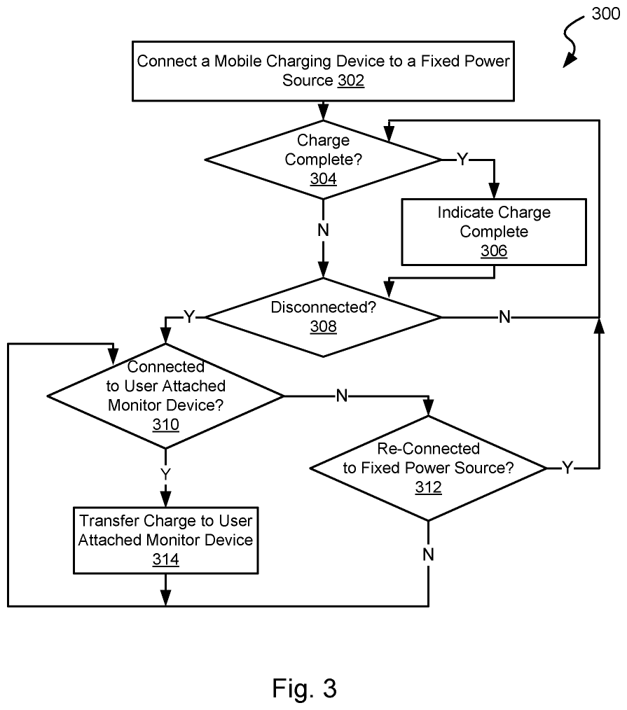

In addition, user attached monitor device 110 includes a set of shielding sensors 169 that are capable of determining whether user attached monitor device 110 is being shielded from receiving GPS signals and/or if GPS jamming is ongoing, a set of device health indicators 154, a tamper sensor 151 capable of determining whether unauthorized access to user attached monitor device 110 has occurred or whether user attached monitor device 110 has been removed from an associated individual being monitored, and/or a motion/proximity sensor 152 capable of determining whether user attached monitor device 110 is moving and/or whether it is within proximity of an individual associated with user detached monitor device (not shown-see FIG. 3) associated with the monitored individual. In some cases, motion/proximity sensor 152 includes one or more accelerometer sensors and/or vibration gyro sensors that are capable of accurately sensing motion of the monitored individual. In addition, motion/proximity sensor 152 includes sensors capable of determining a proximity of user attached monitor device 110 to a monitored individual to which the device is assigned. This information may be used to assure that the monitored individual is wearing user attached monitor device 110. Based on the disclosure provided herein, one of ordinary skill in the art will recognize a variety of shielding sensors, a variety of device health transducers and indicators, a variety of tamper sensors, various different types of motion sensors, different proximity to human sensors, and various human body physical measurement sensors or transducers that may be incorporated into user attached monitor device 110 according to various different instances and/or embodiments.

In some embodiments, a user input (not shown) may be integrated into a display 159 and allows for a user of user attached monitor device 110 to provide information to user attached monitor device 110. Display 159 is communicatively coupled to controller circuit 167.

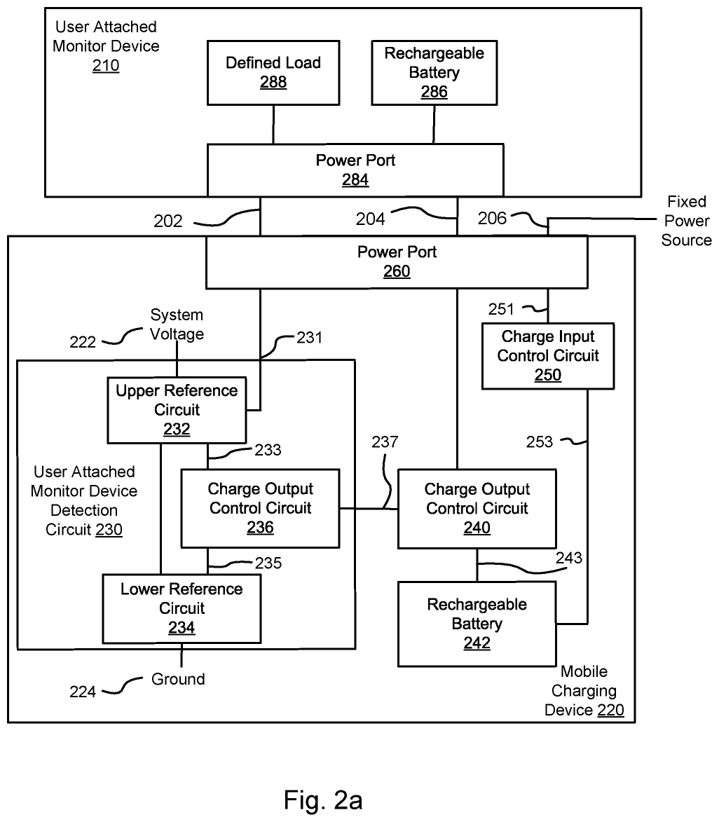

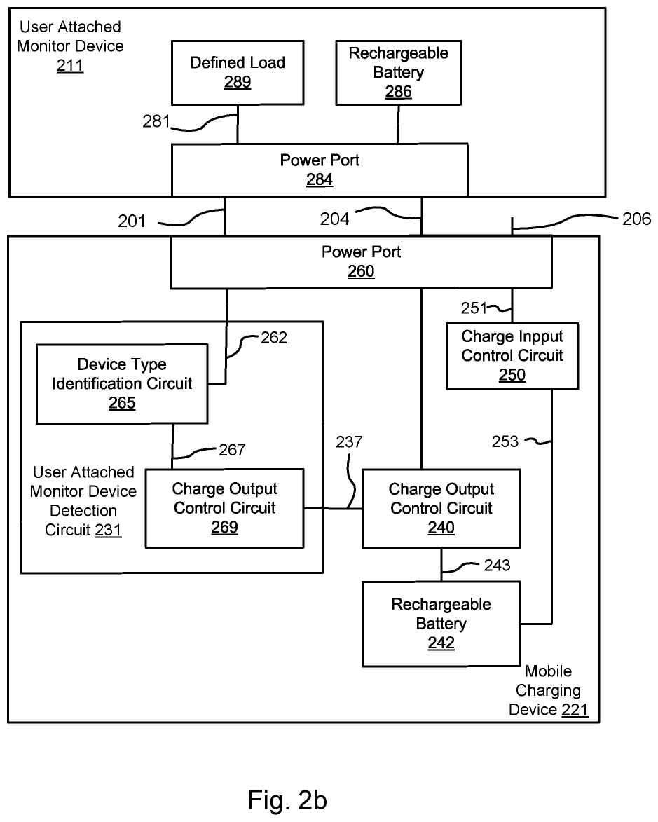

A power port 3084 may be a physical interface configured for connection to a corresponding port (not shown) or a mobile charging device (not shown). Examples of mobile charging devices that may be used in relation to different embodiments are discussed below in relation to FIGS. 2a-2b. Power port 3084 may include a number of electrodes through which data and an electrical charge can be passed between the mobile charging device and user attached monitor device 110. Charge passed from the mobile charging device to user attached monitor device 110 via power port 3084 is provided to rechargeable battery 3086. In some cases, power port 3084 includes a charging circuit used to convert the received power to that needed by rechargeable battery 3086.

Power port 3084 is connected to a defined load 3088. When connected via an electrode of power port 3084, defined load 3088 provides an identifying signal to user attached monitor device 110 to a connected mobile charging device. This identifying signal is used by the connected mobile charging device to determine whether to enable power to flow to rechargeable battery 3086. As more fully discussed below in relation to FIG. 2a, in embodiments where the connected mobile charging device uses a voltage divider circuit to discern whether to enable power to flow to user attached monitor device 110, defined load 3088 may be a resistive load that when sensed by the connected mobile charging device causes the enable. In such a case, the identifying signal does not uniquely identify the particular user attached monitor device, but rather only identifies a connected device as having a load characteristic of a user attached monitor device.

As more fully discussed below in relation to FIG. 2b, in other embodiments where the connected mobile charging device uses an identification comparison circuit, defined load 3088 provides an output signal with a predetermined coding. The output signal may be transferred via a single electrode on power port 3084 or multiple electrodes on power port 3084. The provided signal may be unique to the particular user attached monitor device 110 or may only indicate a certain group or class of devices. In some particular embodiments, the output signal from defined load 3088 is generated based in part on device ID 161. Based upon the disclosure provided herein, one of ordinary skill in the art will recognize a variety of signals that may be provided from defined load 3088 to the connected mobile charging device in accordance with different embodiments.

Turning to FIG. 1c, a user attached monitor device 2065 is shown with an example attachment element 2090 connected at opposite ends of user attached monitor device 2065 (i.e., a first end 2096 and a second end 2098). User attached monitor device 2065 is one example implementation of user attached monitor device 110 of FIGS. 1a-1b. Attachment element 2090 has an outer surface 2092 and an inner surface 2091. Attachment element 2090 is operable to securely attach a user attached monitor device 2065 to a limb of an individual in accordance with some embodiments. In some cases, attachment element 2090 is tailored to attach to a wrist of a monitored individual. In various embodiments, attachment element 2090 includes electrically and/or optically conductive material used to make a conductive connection from first end 2096 to second end 2098 through attachment element 2090 and is used in relation to determining whether user attached monitor device 2065 remains attached and/or has been tampered with. Thus, for example, where attachment element 2090 is cut, the conductive connection is broken indicating a tamper has occurred. While FIG. 1c shows a strap as an example attachment element, based upon the disclosure provided herein, one of ordinary skill in the art will recognize other types of attachment elements that may be used in relation to different embodiments. In other embodiments, attachment element 2090 is long enough to attach around the torso of the monitored individual and is sufficiently flexible to allow expansion and contraction of the chest of the monitored individual as they breathe. Such expansion and contraction may be used to sense respiration rate of the monitored individual.

User attached monitor device 2065 includes a case 2089 in which various electronic components are maintained. In addition, user attached monitor device 2065 includes a button 2083, a radial dial 2085, a display 2087 (which may be a touchscreen display), and a combination speaker, microphone, and image sensor 2079. User attached monitor device 2065 includes a power port 2084 that includes a number of electrodes 2083 (e.g., male and/or female electrodes) through which data and an electrical charge can be passed between the mobile charging device and user attached monitor device 2065. User attached monitor device 2065 may further include: a radial dial 2085, a display 2087, a combination speaker, microphone, and image sensor 2079 provide the user interface for user attached monitor device 2065 and support the functionality of the various sensors discussed above in relation to FIG. 1b. Based upon the disclosure provided herein, one of ordinary skill in the art will recognize a variety of inputs and outputs that may be incorporated into user attached monitor device 2065 to provide the functionality discussed herein.

Turning to FIG. 1d, a user attached monitor device 1100 is shown with an example attachment element 1090 connected at opposite ends of a case 1089. User attached monitor device 1100 is another example implementation of user attached monitor device 110 of FIGS. 1a-1b. Attachment element 1090 is configured to securely attach a case 1089 to a limb of an individual in accordance with some embodiments. In various embodiments, attachment element 1090 includes electrically and/or optically conductive material used to make a conductive connection from one side of case 1089 to the opposite side of case 1089 and is used in relation to determining whether user attached monitor device 1100 remains attached and/or has been tampered with. While FIG. 1d shows a strap as an example attachment element, based upon the disclosure provided herein, one of ordinary skill in the art will recognize other types of attachment elements that may be used in relation to different embodiments. User attached monitor device 1100 includes a power port 1084 that includes a number of electrodes (e.g., male and/or female electrodes) through which data and an electrical charge can be passed between the mobile charging device and user attached monitor device 1100.

Turning to FIG. 2a, a block diagram of a mobile charging device 220 configured to charge a user attached monitor device 210 is shown in accordance with some embodiments. User attached monitor device 210 is shown as including a power port 284, a rechargeable battery 286, and a defined load 288. User attached monitor device 210 may be implemented, for example, similar to user attached monitor device 110 discussed above in relation to FIGS. 1a-1b. In such an example, power port 284 includes the functionality of power port 3084, and rechargeable battery 286 includes the functionality of rechargeable battery 3086. Defined load 288 includes a resistive load. In some embodiments, the resistive load is a high resistance designed to operate in concert with an upper reference circuit 232 of mobile charging device 220 to yield a voltage output 233 indicative of user attached monitor device 210 being attached to mobile charging device 220 as more fully described below.

As shown, power port 284 is electrically coupled to a power port 260 of mobile charging device 221 via an electrode 202 and an electrode 204. There may be more electrodes connections between power port 284 and power port 260 that are not discussed herein. Power port 260 additionally includes an electrode 206 configured for connection to a fixed power source. In some embodiments, electrode 206 is not included as a separate electrode, but rather the function of electrode is done by another electrode (e.g., electrode 204) on power port 260.

Mobile charging device 220 includes a user attached monitor device detection circuit 230 that is configured to determine whether user attached monitor device 210 is connected. User attached monitor device detection circuit 230 includes an upper reference circuit 232, a lower reference circuit 234, and a charge output control circuit 236. Upper reference circuit 232 is attached to a system voltage 222, and a signal input 231. When mobile charging device 220 is not connected to user attached monitor device 210, signal input 231 appears as an open (infinite resistance), resulting in voltage output 233 being a first voltage. In contrast, when mobile charging device 220 is connected to user attached monitor device 210, signal input 231 appears as a finite load (finite resistance), resulting in voltage output 233 being a second voltage. In some embodiments, the first voltage is higher than the second voltage. In various embodiments, the first voltage is more than ten (10) percent higher than the second voltage. In some embodiments, the first voltage is more than twenty (20) percent higher than the second voltage.

Lower reference circuit 234 is connected to a ground 224 and to upper reference circuit 232. When mobile charging device 220 is not connected to user attached monitor device 210, lower reference circuit 234 provides a voltage output 235 being a third voltage. The third voltage is less than the first voltage and the second voltage. In contrast, when mobile charging device 220 is connected to user attached monitor device 210, lower reference circuit 234 provides voltage output 235 as a fourth voltage. The fourth voltage is greater than the third voltage and less than the second voltage.

Charge output control circuit 236 may be a window comparator circuit where an enable output 237 is asserted whenever voltage output 233 is less than a threshold between the first voltage and the second voltage, and voltage output 235 is greater than a threshold between the third voltage and the fourth voltage. Outside of this window, charge output control circuit 236 de-asserts enable output 237. Enable output 237 is provided to a charge output control circuit 240.

When enable output 237 is asserted, charge output control circuit 240 allows charge 243 from a rechargeable battery 242 to flow to rechargeable battery 286 via electrode 204. Otherwise, charge from rechargeable battery 242 is not allowed to move from rechargeable battery 242. Charge output control circuit 240 may be any circuit known in the art for selectively controlling charge transfer.

A charge input control circuit 250 is configured to sense whether power port 260 is connected to a fixed power source. Where charge input control circuit 250 senses a connection to a fixed power source, charge 251 from the fixed power source is transferred to rechargeable battery 242 via a connection 253. Charge input control circuit 250 may be any circuit known in the art for selectively controlling charge transfer.

Turning to FIG. 2b, a block diagram of a mobile charging device 221 configured to charge a user attached monitor device 211 is shown in accordance with some embodiments. User attached monitor device 211 is shown as including a power port 284, a rechargeable battery 286, and a defined load 289. User attached monitor device 211 may be implemented, for example, similar to user attached monitor device 110 discussed above in relation to FIGS. 1a-1b. In such an example, power port 284 includes the functionality of power port 3084, and rechargeable battery 286 includes the functionality of rechargeable battery 3086. Defined load 289 includes signal generating circuit configured to output a signal 281 identifying user attached monitor device 211. In some embodiments, signal 281 is a parallel signal provided via an electrode group 201. Electrode group 201 includes two or more electrodes where each of the two or more electrodes carries a part of the parallel signal. In other embodiments, signal 281 is a series signal provided via electrode group 201. In such an embodiment, electrode group 201 may be a single electrode that carries the series signal.

As shown, power port 284 is electrically coupled to a power port 260 of mobile charging device 221 via a electrode group 201 and electrode 204. There may be more electrodes connections between power port 284 and power port 260 that are not discussed herein. Power port 260 additionally includes an electrode 206 configured for connection to a fixed power source. In some embodiments, electrode 206 is not included as a separate electrode, but rather the function of electrode is done by another electrode (e.g., electrode 204) on power port 260.

Mobile charging device 221 includes a user attached monitor device detection circuit 231 that is configured to determine whether user attached monitor device 211 is connected. User attached monitor device detection circuit 231 includes a device type identification circuit 265 and a charge output control circuit 269. Device type identification circuit 265 receives signal 281 via electrode group 201 and connection 262. Device type identification circuit receives signal 281 and compares it with a predetermined value to determine whether it corresponds to a user attached monitor device. Device type identification circuit 265 may be any circuit known in the art that is capable of receiving an input signal, identifying information in the input signal, and comparing that information with a predetermined pattern.

When mobile charging device 221 is not connected to user attached monitor device 211, signal 281 will not be available via connection 262. In such a situation, device type identification circuit de-asserts a connected indicator 267. In contrast, when mobile charging device 221 is properly connected to user attached monitor device 211, signal input 231 appears as an open, signal 281 will be available via connection 262. In such a situation, device type identification circuit asserts a connected indicator 267.

Connected indicator 267 is provided to charge output control circuit 269. When connection indicator 267 is asserted, charge output control circuit 269 asserts an enable output 237. Otherwise, charge output control circuit 269 de-asserts enable output 237. Enable output 237 is provided to charge output control circuit 240.

When enable output 237 is asserted, charge output control circuit 240 allows charge 243 from a rechargeable battery 242 to flow to rechargeable battery 286 via electrode 204. Otherwise, charge from rechargeable battery 242 is not allowed to move from rechargeable battery 242. Charge output control circuit 240 may be any circuit known in the art for selectively controlling charge transfer.

Charge input control circuit 250 is configured to sense whether power port 260 is connected to a fixed power source. Where charge input control circuit 250 senses a connection to a fixed power source, charge 251 from the fixed power source is transferred to rechargeable battery 242 via a connection 253. Charge input control circuit 250 may be any circuit known in the art for selectively controlling charge transfer.

Turning to FIG. 3, a flow diagram 300 shows a method in accordance with some embodiments for utilizing a mobile charging device configured to charge a user attached monitor device. Following flow diagram 300, the mobile charging device is connected to a fixed power source (block 302). The fixed power source may be, but is not limited to, a wall power outlet. Using FIG. 2a as an example, connecting the mobile charging device to the fixed power source may include connecting electrode 206 to the fixed power source.

It is determined whether the mobile charging device is completely charged (block 304). Where it is completely charged (block 304), a charge complete is indicated (block 306). Indicating the complete charge may be done, for example, by lighting a diode on the mobile charging device. Based upon the disclosure provided herein, one of ordinary skill in the art will recognize a variety of approaches for indicating a completed charge that may be used in relation to different embodiments.

It is determined whether the mobile charging device has been disconnected from the fixed power source (block 308). Using FIG. 2a as an example, this may be done by charge input control circuit 250 sensing a low voltage condition on electrode 206. Based upon the disclosure provided herein, one of ordinary skill in the art will recognize a variety of methods that may be used in relation to different embodiments for determining that the mobile charging device has been disconnected from the fixed power source.

Where the mobile charging device has not been disconnected from the fixed power source (block 308), the charging process continues. Alternatively, where the mobile charging device has been disconnected from the fixed power source (block 308), it is determined whether the mobile charging device has been connected to a user attached monitor device (block 310). Using FIG. 2a as an example, determining the connection may be done by performing a window comparison of voltages that are influenced by connection to a finite load in the user attached monitor device. Using FIG. 2b as another example, determining the connection may be done by comparing a signal received from a user attached monitor device.

Where it is determined that a user attached monitor device is connected to the mobile charging device (block 310), charge is transferred from a rechargeable battery of the mobile charging device to a rechargeable battery of the user attached monitor device (block 314). Alternatively, where it is determined that a user attached monitor device is not connected to the mobile charging device (block 310), it is determined whether the mobile charging device has been reconnected to the fixed power source (block 312). Where it has been reconnected to the fixed power source (block 312), charging of the rechargeable battery in the mobile charging device resumes.

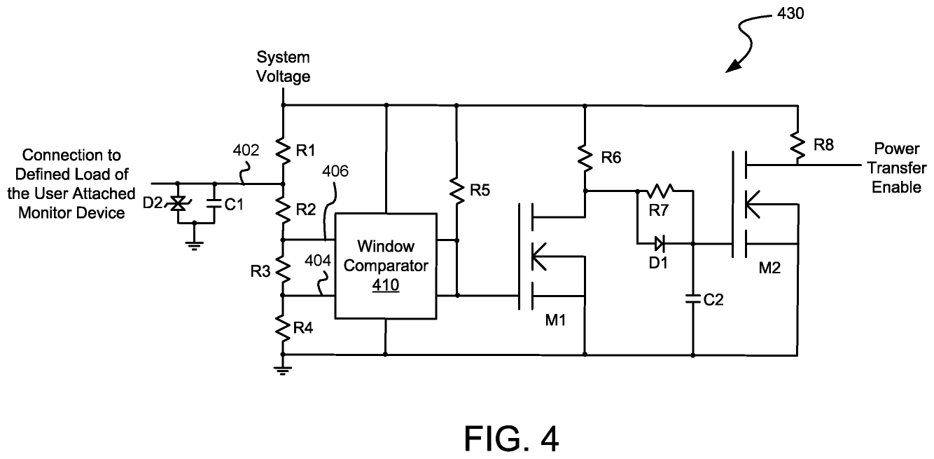

Turning to FIG. 4, a schematic diagram of a user attached monitor device detection circuit 430 is shown in accordance with some embodiments. In some embodiments, user attached monitor device detection circuit 430 may be used in place of user attached monitor device detection circuit 230 discussed above in relation to FIG. 2a. As shown, user attached monitor device detection circuit 430 includes an input circuit 402 comprising a capacitor C1 and a diode D2. The input circuit connects user attached monitor device detection circuit 430 to a defined load of a user attached monitor device, and is configured to delay any reaction to the connection by a time constant controlled by C1. A combination of resistors R1, R2, R3, R4 provide both an upper reference circuit corresponding to upper reference circuit 232 discussed above in relation to FIG. 2a and a lower reference circuit corresponding to lower reference circuit 234 discussed above in relation to FIG. 2a. The combination of resistors R1, R2, R3, R4 operate to provide a first voltage 406 and a second voltage 406 that each vary based upon a combination of the defined load of the user attached monitor device being put in parallel with the other resistors.

First voltage 404 and second voltage 402 are provided to a window comparator circuit 410. When first voltage 406 is below a reference voltage and second voltage 404 is above a reference voltage, a power transfer enable signal is asserted. The power transfer enable signal corresponds to enable output 237 of FIG. 2a. The combination of C2, R7, and D1 create a delay between switching of the power transfer enable signal. D1 causes the delay to be different depending upon the direction of the switching. In one embodiment where the system voltage is 3.6 volts, the defined load in the user attached monitor device is selected such that the voltage from input circuit 402 is 1.9 volts. In some such embodiments, window comparator 410 causes the power transfer enable signal to assert whenever the voltage from input circuit 402 is between 1.0 and 2.5 volts.

Where, on the other hand, the voltage from input circuit 402 is less than 1.0 volts, window comparator 410 causes the power transfer enable signal to de-assert. This occurs, for example, where the defined load is shorted. Alternatively, where the voltage from input circuit 402 is greater than 2.5 volts, window comparator 410 causes the power transfer enable signal to de-assert. This occurs, for example, where the defined load is open.

In conclusion, the present invention provides for novel systems, devices, and methods for maintaining a user attached monitor device. While detailed descriptions of one or more embodiments of the invention have been given above, various alternatives, modifications, and equivalents will be apparent to those skilled in the art without varying from the spirit of the invention. Therefore, the above description should not be taken as limiting the scope of the invention, which is defined by the appended claims.

What is claimed is:

1. A method for maintaining a user attached monitor device, the method comprising:
providing a user attached monitor device, wherein the user attached monitor device comprises:
a first rechargeable battery;
a tool for determining a characteristic of a monitored individual;
a securing mechanism for securing the user attached monitor device to the monitored individual;
a first power port;
a defined load;
connecting a mobile charging device to the user attached monitor device while the user attached monitor device is secured to the monitored individual, wherein the mobile charging device comprises:
a second rechargeable battery;
a second power port; and
a user attached monitor device detection circuit configured to determine whether the user attached monitor device is attached to the mobile charging device via the first power port and the second power port;
upon determination by the user attached monitor device detection circuit that the user attached monitor device is attached to the mobile charging device, providing power from the second rechargeable battery to the first rechargeable battery via the first power port and the second power port; and
upon determination by the user attached monitor device detection circuit that the user attached monitor device is not attached to the mobile charging device, disabling power transfer from the second rechargeable battery.

2. The method of claim 1, wherein the tool comprises a location tool configured to determine a location of the user attached monitor device.

3. The method of claim 1, wherein the tool comprises a tamper tool configured to determine whether the user attached monitor device remains secured to the monitored individual.

4. The method of claim 1, wherein the tool comprises a substance detection tool configured to determine whether the monitored individual is impaired.

5. The method of claim 1, wherein the defined load comprises a finite resistance, and wherein the finite resistance interacts with a resistance in the user attached monitor device detection circuit to generate a voltage signal.

6. The method of claim 5, wherein the user attached monitor device detection circuit comprises a window comparator circuit configured to assert an enable signal when the voltage signal is between a lower threshold and an upper threshold.

7. The method of claim 6, wherein the finite resistance and a resistance in the user attached monitor device detection circuit are selected such that the enable signal is asserted when the voltage signal is between one (1.0) and two and one half (2.5) volts.

8. The method of claim 6, wherein the finite resistance and a resistance in the user attached monitor device detection circuit are selected such that the enable signal is asserted for a range of less than one and one half (1.5) volts.

9. The method of claim 6, wherein the finite resistance and a resistance in the user attached monitor device detection circuit are selected such that the enable signal is asserted for a range of less than one half (0.5) volts.

10. A charging apparatus, the apparatus comprising:
a rechargeable battery;
a power port; and
a user attached monitor device detection circuit configured to determine whether a user attached monitor device is attached to the mobile charging device via the power port, and to assert an enable signal when the user attached monitor device is attached to the mobile charging device; and
a power transfer enable circuit configured to disable power transfer from the rechargeable battery to the user attached monitor device when enable signal is de-asserted.

11. The charging apparatus of claim 9, wherein the user attached monitor device detection circuit is configured to detect a defined load in the user attached monitor device.

12. The charging apparatus of claim 11, wherein the user attached monitor device detection circuit includes a series of resistors generating: a first voltage when the user attached monitor device detection circuit is not connected to the defined load, and a second voltage when the user attached monitor device is connected to the defined load.

13. The charging apparatus of claim 12, wherein the user attached monitor device detection circuit is configured to assert the enable signal when at least the second voltage is generated by the series of resistors.

14. The charging apparatus of claim 11, wherein the user attached monitor device detection circuit includes a series of resistors generating: a first voltage and a second voltage when the user attached monitor device detection circuit is not connected to the defined load, and a third voltage and a fourth voltage when the user attached monitor device is connected to the defined load.

15. The charging apparatus of claim 14, wherein the user attached monitor device detection circuit is configured to assert the enable signal when both the first voltage is below a first threshold and the second voltage is above a second threshold.

16. The charging apparatus of claim 15, wherein the first threshold is greater than the second threshold.

17. A system for monitoring an individual, the system comprising:
a user attached monitor device, wherein the user attached monitor device comprises:
a first rechargeable battery;
a tool for determining a characteristic of a monitored individual;
a securing mechanism for securing the user attached monitor device to the monitored individual;
a first power port;
a defined load;
a mobile charging device attachable to the user attached monitor device while the user attached monitor device is attached to a monitored individual, the mobile charging device comprising:
a second rechargeable battery;
a second power port; and
a user attached monitor device detection circuit configured to determine whether the user attached monitor device is attached to the mobile charging device via the first power port and the second power port, and to assert an enable signal when the user attached monitor device is attached to the mobile charging device; and
a power transfer enable circuit configured to disable power transfer from the second rechargeable battery to the first rechargeable battery when enable signal is de-asserted, and to enable power transfer from the second rechargeable battery to the first rechargeable battery when enable signal is asserted.

18. The system of claim 17, wherein the user attached monitor device detection circuit is configured to detect a defined load in the user attached monitor device.

19. The system of claim 18, wherein the user attached monitor device detection circuit includes a series of resistors generating: a first voltage and a second voltage when the user attached monitor device detection circuit is not connected to the defined load, and a third voltage and a fourth voltage when the user attached monitor device is connected to the defined load.

20. The charging apparatus of claim 19, wherein the user attached monitor device detection circuit is configured to assert the enable signal when both the first voltage is below a first threshold and the second voltage is above a second threshold.
